(19) United States
(12) Patent Application Publication
(10) Pub. No.: US 2013/0309716 A1
(43) Pub. Date: Nov. 21, 2013

(54) Methods For Inactiviation And/or Extraction of A Fungus Test Sample For Characterization And/or Identification Using Mass Spectrometry

(71) Applicants: Valérie Monnin, Creys-Mepieu (FR); Victoria Girard, Lyon (FR); Marcel Erhard, Potsdam (DE); Maud Arsac, Saint Chamond (FR)

(72) Inventors: Valérie Monnin, Creys-Mepieu (FR); Victoria Girard, Lyon (FR); Marcel Erhard, Potsdam (DE); Maud Arsac, Saint Chamond (FR)

(73) Assignee: bioMerieux Inc., Durham, NC (US)

(21) Appl. No.: 13/835,620

(22) Filed: Mar. 15, 2013

Related U.S. Application Data
(60) Provisional application No. 61/648,438, filed on May 17, 2012.

(51) Int. Cl. G01N 1/30

(52) U.S. Cl. CPC G01N 1/30
USPC 435/40.51

(57) ABSTRACT

The present invention is directed to a method for inactivation and/or extraction of fungus samples (e.g., mold or yeast samples), the method comprising the following sequential steps: (a) acquiring a test sample known to contain or that may contain fungus and suspending the test sample in a container containing water and/or suspension medium; (b) adding ethanol to the suspension; (c) centrifuging the container to pellet the fungus and removing and discarding the supernatant; (d) resuspending the fungus in formic acid; (e) adding acetonitrile to the sample; (f) centrifuging the sample; and (g) recovering the supernatant. In accordance with the present invention, the recovered supernatant can be subjected to mass spectrometry analysis for characterization and/or identification of the unknown fungus.

### CROSS REFERENCE TO RELATED APPLICATION

This application claims the benefit of U.S. Provisional Patent Application No. 61/648,438, entitled, “Methods for Inactivation and Extraction of a Fungus Test Sample for Characterization and/or Identification using Mass Spectrometry”, filed May 17, 2012, which is incorporated herein.

### FIELD OF THE INVENTION

The present invention relates to methods for the inactivation and/or extraction of a fungus test sample for characterization and/or identification using mass spectrometry. In particular, the present invention is directed to a method for the rapid characterization and/or identification of mold and yeast species using mass spectrometry.

### BACKGROUND OF THE INVENTION

Traditional automated phenotypic ID tests, such as the Vitek®, Phoenix and Microscan® systems, or manual phenotypic tests such as API require that microorganisms be in an appropriate growth phase and free of interfering media and blood products in order to provide robust results. These systems use colonies grown from the positive broth for 18-24 hours on plated media. However, in an effort to obtain faster results, some laboratories have reported using these systems with microorganisms isolated from positive blood culture bottles. These direct-from-the-bottle tests are not appropriate for all microorganisms (e.g., Gram-positive cocci), are not validated by the test manufacturers, and generally take 3-8 hours to provide results. Faster and more broadly specific tests are urgently needed in order to provide the physician with clinically relevant results within the first few hours, preferably within an hour after a positive culture result.

Mass spectrometric methods have the potential to allow for identification of microorganisms very quickly, but may encounter interference from the many compounds present in liquid microbiological culture media and in clinical samples such as blood or combinations thereof. The most commonly employed methods for recovering microorganisms directly from positive blood culture broth are two-step differential centrifugation and centrifugation in a serum separator tube.

Other methods for separation, characterization and/or identification of microorganisms have been described, include:

U.S. Pat. No. 6,177,266 discloses a method for the chemotaxonomic classification of bacteria with genus, species and strain specific biomarkers generated by matrix assisted laser desorption ionization time-of-flight mass spectrometry (MALDI-TOF-MS) analysis of either cellular protein extracts or whole cells.

However, there remains a need in the art for efficient and rapid protocols for the inactivation and/or extraction of microorganism test samples for subsequent analysis, characterization and/or identification by mass spectrometry. In particular, inactivation, or cell death, may be preferred when handling fungus samples, such as molds and yeasts, due to volatile spores which tend to spread easily and may lead to contamination.

### SUMMARY OF THE INVENTION

In one aspect, the present invention is directed to a method for inactivation and/or extraction of a fungus (e.g., a mold or yeast species) in a test sample, the method comprising the following sequential steps: (a) acquiring a test sample from a solid or semi-solid culture medium known to contain or that may contain a fungus (e.g., a mold or yeast species) and suspending the test sample in water or a medium suspension; (b) adding ethanol to the suspension, mixing, and optionally incubating the suspension for at least 3 minutes; (c) centrifuging the container to pellet the fungus and subsequently removing and discarding the supernatant; (d) resuspending the fungus in formic acid and mixing; (e) adding acetonitrile to the sample and mixing; (f) centrifuging the sample; (g) recovering the supernatant for subsequent testing for characterization and/or identification of the unknown fungus. The fungal (e.g., mold or yeast species) sample can be acquired from the solid or semi-solid culture medium using inoculation loop or a swab.

The method may further comprise adding beads and bead beating or vortexing the container in step (b) for about 1 minute to about 30 minutes. In one embodiment, the beads are 0.5 mm glass beads. In one embodiment, the method may further comprise a subsequent incubation step wherein the suspension in step (c) is incubated for at least about 5 minutes.

The pellet in step (d) may be resuspending using from about 50% to about 90% formic acid, or using about 70% formic acid. After resuspening the pellet, acetonitrile can be added to obtain a final concentration of from about 35% to about 65% acetonitrile, or to obtain a final concentration of about 50%. In one embodiment, the pellet may be resuspended in about 40 μL of formic acid in step (e) and about 40 μL of acetonitrile can be added to the resuspended pellet in step (f).

In accordance with another embodiment, the method further comprises the following additional steps: (h) transferring an aliquot of the supernatant from step (g) to a mass spectrometry target slide and adding a matrix solution to the supernatant; and (i) interrogating the test sample on the slide or plate by mass spectrometry to acquire one or more mass spectra of the fungus (e.g., mold or yeast species) and (j) characterizing and/or identifying said fungus in the test sample by comparison of the measured one or more mass spectra with reference mass spectra. Optionally, step (h) comprises transferring an aliquot of the test sample obtained after step (g) to a mass spectrometry slide or plate, allowing the aliquot to dry and subsequently adding a matrix. Any known matrix may be used, for example, the matrix may be alpha-cyano-4-hydroxycinnamic acid (CHCA). In accordance with the present invention, the method can be used for inactivation and/or extraction of mold or yeast for subsequent characterization and/or identification. For example, mold or yeast species can be identified to the genus, species and/or strain level using mass spectrometry, for example, using MALDI-TOF mass spectrometry.

In still another aspect, the present invention is directed to a method for inactivation and/or extraction of fungus (e.g., mold or yeast species) in a test sample followed by interrogation by mass spectrometry for characterization and/or identification of the fungus, the method comprising the following sequential steps: (a) acquiring a test sample from a solid or semi-solid culture medium known to contain or that may contain a fungus and suspending the test sample in a container containing about 300 μL of a suspension medium; (b) adding 900 μL of absolute ethanol (100%) to the suspension and mixing; (c) centrifuging the container to pellet the fungus sample and removing the supernatant; (d) resuspending the fungus pellet in with 40 μL of 70% formic acid and mixing; (e) adding 40 μL acetonitrile to the container and mixing; (f) centrifuging the container to pellet remaining fungus cell debris; (g) recover the supernatant; (h) transferring an aliquot of the supernatant from step (g) to a mass spectrometry target slide and adding a matrix solution to the supernatant; (i) interrogating the test sample on the slide or plate by mass spectrometry to acquire one or more mass spectra of the fungus; and (j) characterizing and/or identifying said fungus in the test sample by comparison of the measured one or more mass spectra with reference mass spectra. In accordance with the present invention, the fungus (e.g., mold or yeast species) can be identified to the genus, species and/or strain level, for example, using MALDI-TOF mass spectrometry.

### BRIEF DESCRIPTION OF THE FIGURES

FIG. 1—shows a flow chart of various method for inactivation and/or extraction of a fungus (e.g., mold or yeast species) from a solid or semi-solid media, in accordance with one embodiment of the present invention. As shown, protocol A uses a bead beating step for mechanical disruption of a fungus sample followed by interrogation of the sample by mass spectrometry. Protocol B employs sequential steps of suspension in water and/or suspension media and addition of ethanol, followed by pelleting by centrifugation, resuspension in formic acid and addition of acetonitrile for extraction and/or inactivation prior to interrogation by mass spectrometry. Finally, protocol C uses a mechanical disruption step in ethanol followed by centrifugation and subsequently resuspension in formic acid and addition of acetonitrile for extraction and/or inactivation prior to interrogation by mass spectrometry.

FIG. 2—shows a flow chart of a method for inactivation and/or extraction of fungus (e.g., mold or yeast), in accordance with another embodiment of the present invention.

### DETAILED DESCRIPTION OF THE INVENTION

The present invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment can be deleted from that embodiment. In addition, numerous variations and additions to the embodiments suggested herein will be apparent to those skilled in the art in light of the instant disclosure, which do not depart from the instant invention.

The present assignee's VITEK® MS system (bioMérieux, Inc., St. Louis, Mo.) provides a platform for microbial identification using a Matrix Assisted Laser Desorption Ionization—Time of Flight (MALDI-TOF) Mass Spectrometer to analyze the protein profile of a sample and match it to a database of known organism profiles. Samples are inoculated onto a target slide, covered with a matrix (e.g., CHCA matrix (α-cyano-4-hydroxy-cinamic acid matrix)), and then processed through the Mass Spectrometer.

Most common clinically-relevant microorganism can be analyzed by inoculating cells directly onto the VITEK® MS target slide. However, inactivation can be preferred in the preparation of fungus (e.g., mold or yeast species) samples for analysis to avoid contamination problems that may occur as a result of spore dispersal.

The present applicants have found that incubation in ethanol provides an effective and rapid method for the inactivation of fungus samples. Additional processing steps can then be used to assist in extracting the cellular proteins from the inactivated cells in order to yield clear and consistent spectra. For example, a treatment step in formic acid followed by exposure to acetonitrile can be used to extract and dissolve proteins for subsequent analysis (e.g., by mass spectrometry).

The present invention provides methods for the inactivation, extraction, characterization and/or identification of an unknown fungus (e.g., mold or yeast species) in a test sample. The present invention is also directed to a method for the rapid characterization and/or identification of a fungus (e.g., mold or yeast species) in a test sample using mass spectrometry. The rapid methods also allow for the characterization and/or identification of fungus species more quickly than prior techniques, resulting in faster diagnoses and characterization/identification of test samples. The steps involved in the methods of the invention, from obtaining a sample to characterization/identification of fungus (e.g., mold or yeast), can be carried out in a very short time frame to obtain clinically relevant actionable information. In certain embodiments, the methods of the invention can be carried out in less than about 120 minutes, e.g., in less than about 110, 100, 90, 80, 70, 60, 50, 40, 30, 20, 15, or 10 minutes. The rapidity of the methods of the invention represents an improvement over prior methods.

Samples that may be tested (i.e., a test sample) by the methods of the invention include both clinical and non-clinical samples in which microorganism presence and/or growth is or may be suspected, as well as samples of materials that are routinely or occasionally tested for the presence of microorganisms. In one embodiment, the sample is suspected of, or known to, contain microorganisms therein. In another embodiment, the sample is taken from a culture, for example, a culture plate containing a solid or semi-solid culture medium.

Non-clinical samples that may be tested also include substances, encompassing, but not limited to, foodstuffs, beverages, pharmaceuticals, cosmetics, water (e.g., drinking water, non-potable water, and waste water), seawater ballasts, air, soil, sewage, plant material (e.g., seeds, leaves, stems, roots, flowers, fruit), blood products (e.g., platelets, serum, plasma, white blood cell fractions, etc.), donor organ or tissue samples, biowarfare samples, and the like. The method is also particularly well suited for real-time testing to monitor contamination levels, process control, quality control, and the like in industrial settings. In another embodiment, the non-clinical sample can be cultured, and a culture sample used. Typically, the clinical sample is cultured, and a culture sample used.

Clinical samples that may be tested include any type of sample typically tested in clinical or research laboratories, including, but not limited to, blood, serum, plasma, blood fractions, joint fluid, urine, semen, saliva, feces, cerebrospinal fluid, gastric contents, vaginal secretions, tissue homogenates, bone marrow aspirates, bone homogenates, sputum, aspirates, swabs and swab rinsates, other body fluids, and the like. Typically, the clinical sample is cultured, and a culture sample used.

In one embodiment of the invention, samples are obtained from a subject (e.g., a patient) having or suspected of having a fungal fungal infection. As used herein, the term “fungus” is intended to encompass any known member of the fungi kingdom, including, but not limited to, mold and yeast strains. In one embodiment, the unknown fungus is Aspergillus.

As used herein, “characterization” encompasses the broad categorization or classification of biological particles and/or the actual identification of a single genus or species of fungus (mold or yeast). Classification may comprise determination of phenotypic and/or morphologic characteristics for the fungus. For example, characterization of the fungus may be accomplished based on observable differences, such as, composition, shape, size, clustering and/or metabolism.

As used herein “identification” means determining to which family, genus, species, and/or strain an unknown fungus (mold or yeast family, genus, species and/or strain.

In one embodiment, the method comprises the following sequential steps: (a) acquiring a test sample from a solid or semi-solid culture medium known to contain or that may contain a fungus (e.g., mold or yeast) and resuspending the test sample in a container containing water and/or a suspension medium; (b) adding ethanol to the suspension, and optionally incubating the suspension for at least 3 minutes; (c) centrifuging the container to pellet the fungus and removing and discarding the supernatant; (d) resuspending the fungus in formic acid and mixing; (e) adding acetonitrile to the sample and mixing; (f) centrifuging the sample; (g) recovering the supernatant for subsequent testing for characterization and/or identification of the unknown fungus. For example, in one embodiment, the supernatant is subjected to mass spectroscopy for characterization and/or identification of the fungus. Typically, the fungus test sample can be acquired in any known way, for example, the fungus test sample can be acquired from the solid or semi-solid culture medium, for example, fungus colony can be picked from the culture medium using inoculation loop or a swab. In one embodiment, a fungus colony is picked from a solid or semi-solid culture medium using a wet swab. For example, a swab can be wetted using water and/or a suspension medium prior to picking a colony from a culture plate. Applicants have found that the use of a wet swab can limit and possible contamination that may otherwise occur as a result of spore dispersion.

In one embodiment, the container in step (a) may contain from about 20 μL to about 1 mL of water and/or suspension medium, or from about 50 μL to about 750 μL, from about 100 μL to about 500 μL, or about 300 μL of water and/or suspension medium. After the fungus test sample has been resuspended, ethanol is added in step (b) to the test sample suspension for inactivation and/or extraction of the fungus test sample. For example, from about 100 μL to about 2 mL, or from about 250 μL to about 1.5 mL, from about 500 μL to about 1 mL, or about 900 μL of ethanol can be added. The ethanol added to the container can be from about 50% to about 100% ethanol, from about 60% to about 90% ethanol, or about 50%, 60%, 70%, 80% or 90% ethanol.

In another embodiment, incubation in ethanol in conjunction with mechanical disruption provides an effective and rapid method for the inactivation of fungus samples. Ethanol exposure was shown to be effective when using a process involving a mechanical disruption step. In one embodiment, mechanical disruption is performed using a bead beater (BioSpec, Bartlesville, Okla.), a homogenizer that disrupts cells by agitating a sealed micro centrifuge vial containing sample, extraction solution, and beads (e.g., tiny glass beads). Typically, the beads can be any known beads that can operate to disrupt cells in a container or microcentrifuge tube. For example, the beads can be glass, glass, ceramic, zirconia, silicon, metal, steel, tungsten carbide, garnet, sand, or sapphire beads. In one embodiment, the bead can be from about 0.1 mm to about 1 mm in size, for example, about 0.5 mm in size. In one embodiment, the beads are 0.5 mm glass beads. Typically, the container is subjected to disruption by beating or vortexing the container in step (b) for about 1 minute to about 30 minutes, for about 5 minutes to about 15 minutes, or for about 5 minutes.

In another embodiment, after the fungus in the test sample has been disrupted, the container, and thus, the fungus in the test sample, are subjected to inactivation by incubating the container for at least 3 minutes. In one embodiment, the incubation step can be for at least 5 minutes or at least 10 minutes. In another embodiment, the incubation step can be for about 3 minutes to about 30 minutes, for about 5 minutes to about 20 minutes, for about 10 minutes to about 15 minutes, or for about 5, 10, 15, 20 or 30 minutes.

After the ethanol addition, and optionally after the incubation and/or mechanical disruption steps, the test sample is subjected to centrifugation in step (c). In general, the centrifugation step needs to be carried out at a sufficient speed, and for a sufficient time, to pellet the fungus in the test sample. For example, the centrifugation acceleration can be about 1,000×g to about 20,000×g, e.g., about 2,500×g to about 15,000×g, e.g., about 7,500×g to about 12,500×g, etc. The centrifugation time can be about 30 seconds to about 30 minutes, e.g., about 1 minute to about 15 minutes, e.g., about 1 minute to about 5 minutes. In one embodiment, the test sample is centrifuges at about 2,500 g to about 10,000 g for about 1 minute to about 10 minutes.

After centrifugation, the fungus pellet can be resuspended in step (d) in the container with formic acid. For example, the fungus pellet can be resuspended in about 5 μL to about 200 μL of formic acid, or with about 10 μL to about 100 μL, with about 20 μL to about 50 μL, or with about 40 μL of formic acid. The pellet may be resuspending using from about 50% to about 90% formic acid, from about 60% to about 80% formic acid, or about 50%, 60%, 70%, 80% or 90% formic acid. Typically, about 70% formic acid is used for resuspension of the fungus pellet. After resuspening the fungus pellet in formic acid, acetonitrile is added in step (e) to obtain a final concentration of from about 35% to about 65%, to obtain a final concentration of from about 40% to about 60%, or to obtain a final concentration of about 35%, 40%, 50%, 60%, or 65% acetonitrile. Typically, 100% acetonitrile is used for this step.

In another embodiment, the pellet may be resuspended in at least about 3, 5 or 10 μL of formic acid in step (d) and at least 3, 5 or 10 μL of acetonitrile can be added to the resuspended pellet in step (e). In another embodiment, the pellet may be resuspended using from about 5 μL to about 100 μL of formic acid, about 10 μL to about 80 μL formic acid, about 10 μL to about 50 μL of formic acid, or about 5, 10, 15, 20, 25, 30, 40, 50, 60, 70, 80, 90 or 100 μL formic acid. In another embodiment, after resuspending the pellet, at least about 3, 5 or 10 μL of acetonitrile are added to the resuspended pellet. For example, from about 5 μL to about 100 μL acetonitrile, from about 10 μL to about 80 μL acetonitrile, 10 μL to about 50 μL acetonitrile, or about 5, 10, 15, 20, 25, 30, 40, 50, 60, 70, 80, 90 or 100 μL acetonitrile, may be added to the resuspended sample.

After resuspension of the pellet in formic acid and addition of acetonitrile, the test sample is subjected to a second centrifugation step, step (f). In general, this second centrifugation step is at a sufficient acceleration, and for a sufficient time, to pellet cell debris remaining from the extraction step. The centrifugation acceleration can be about 1,000×g to about 20,000×g, e.g., about 2,500×g to about 15,000×g, e.g., about 7,500×g to about 12,500×g, etc. The centrifugation time can be about 30 seconds to about 30 minutes, e.g., about 1 minute to about 15 minutes, e.g., about 1 minute to about 5 minutes. In one embodiment, the test sample is centrifuges at about 2,500 g to about 10,000 g for about 1 minute to about 10 minutes. After the centrifugation step, in step (g) the supernatant can be recovered and subjected to subsequent analysis.

The present invention provides methods for characterization and/or identification of an unknown fungus (e.g., mold or yeast) using mass spectrometry, e.g., using matrix assisted laser desorption ionization time-of-flight (MALDI-TOF mass spectrometry). In accordance with the present invention, the characterization and/or identification steps may follow the inactivation and/or extraction steps described above.

In accordance with this embodiment, the method further comprises the following additional steps: transferring an aliquot of the supernatant from step (g) to a mass spectrometry target slide and adding a matrix solution to the supernatant (step (h)); and interrogating the test sample on the slide or plate by mass spectrometry to acquire a mass spectrum of the fungus (step (i)) and characterizing and/or identifying said fungus in the test sample by comparison of the measured mass spectrum with reference mass spectra (step (j)). Optionally, the transferred aliquot can be from about 0.5 μL to about 2.5 μL, or about 1 μL. As is well known in the art, the aliquot is typically allowed to dry and subsequently a matrix solution is added. In general, any known matrix in the art can be used. For example, in one embodiment, the matrix is alpha-cyano-4-hydroxycinnamic acid (CHCA). In accordance with the present invention, the fungus (e.g., mold or yeast) can be identified to the genus, species and/or strain level using MALDI-TOF mass spectrometry, as described further hereinbelow.

In one embodiment, the method allows for acquisition of a high quality spectrum, or spectra, from an unknown fungal test sample containing a sufficient number of peaks for subsequent discrimination and/or identification of a mold or yeast species. For example, the spectra obtained following the methods of the present invention may contain from about 25 to about 200 peaks, or from about 50 to about 150 peaks, or from about 80 to about 120 peaks. In other embodiment, the spectra obtained using the methods of the present invention may contain at least 50, at least 80, or at least 100 peaks. In another embodiment, the method allows for acquisition of a spectra having sufficient resolution for discrimination and/or identification of an unknown fungal test sample by comparison of the obtain spectrum, or spectra, to one or more reference mass spectra (or a database of reference mass spectra), as described in more detail herein.

After the mass spectrometry plate or slide has been prepared the slide or plate is inserted into the mass spectrometer. After the time required to pump the sample down (i.e. remove atmospheric gases from the sample so that it is in an environment of 10-5 to 10-7 torr), the sample is introduced into the ionization chamber of the mass spectrometer. The sample is aligned with the system. When optimal alignment is achieved, the nitrogen laser is pulsed. The absorption of the laser energy by the matrix causes it to ablate from the plate's surface due to the high energy deposited. As a side effect, portions of the fungal cells are also vaporized and ionized in the process. These ions are accelerated to a known kinetic energy by the generation of an electrostatic field between the plate and the entrance to the mass spectrometer's flight tube (i.e. this portion of the system is the mass/charge discriminator). All singly charged ions, regardless of mass, will have the same kinetic energy at the entrance to the flight tube, but they will have velocities that are inversely proportional to their masses. From there, ions move down the flight tube towards the detector, and lighter ions will arrive before heavier ions (the flight tube is the mass/charge discriminator). The detector generates an electrical charge every time an ion impacts the detector. The output of the detector is digitized and the output displays mass/charge ratio on one axis and number of impacts on the other axis. In one embodiments, the fungus (e.g., mold or yeast) on the slide or plate can be interrogated using any known mass spectrometry techniques, such as MALDI-TOF mass spectrometry, desorption electrospray ionization (DESI) mass spectrometry, GC mass spectrometry, LC mass spectrometry, electrospray ionization (ESI) mass spectrometry and Selected Ion Flow Tube (SIFT) spectrometry, or other known mass spectrometry technique.

According to the invention, control measurements are taken for known fungal samples, thus allowing for correlation of measured test data with characterization of the fungus of interest using various mathematical methods known to those skilled in the art. For example, the data from samples may be compared with the baseline or control measurements utilizing software systems known to one skilled in the art. More particularly, the data may be analyzed by a number of multivariate analysis methods, such as, for example, General Discriminant Analysis (GDA), Partial Least Squares Discriminant Analysis (PLSDA), Partial Least Squares regression, Principal Component Analysis (PCA), Parallel Factor Analysis (PARAFAC), Neural Network Analysis (NNA) and/or Support Vector Machine (SVM). These methods may be used to classify unknown fungus (e.g., mold or yeast species) of interest into relevant groups based on existing nomenclature, and/or into naturally occurring groups based on the organism's metabolism, pathogenicity and/or virulence in designing the system for monitoring, detecting and/or characterizing the organism as described previously. In one embodiment, after acquisition of a one or more mass spectra for the unknown fungus sample, the one or more mass spectra can be input into the “Saramis” microorganism identification software (bioMérieux, Inc., St. Louis, Mo.) for analysis, and thus, for characterization and/or identification of the fungus. In another embodiment, after acquisition of a one or more mass spectra for the unknown fungus sample, the one or more mass spectra can be input into the “SpectraIdentifier” microorganism identification software (bioMérieux, Inc., St. Louis, Mo.) for analysis, and thus, for characterization and/or identification of the fungus.

In yet another embodiment, non-spectroscopic measurements from the detection system, such as detection times and growth rates can be used to assist in the characterization and/or identification of fungus from test sample.

In some embodiments of the invention, characterization and/or identification of the fungus in the test sample need not involve identification of an exact species. As noted above, characterization may encompass the broad categorization or classification of biological particles as well as the actual identification of a single species. As used herein “identification” means determining to which family, genus, species, and/or strain a previously unknown fungus belongs to. For example, identifying a previously unknown fungus to the family, genus, species, and/or strain level.

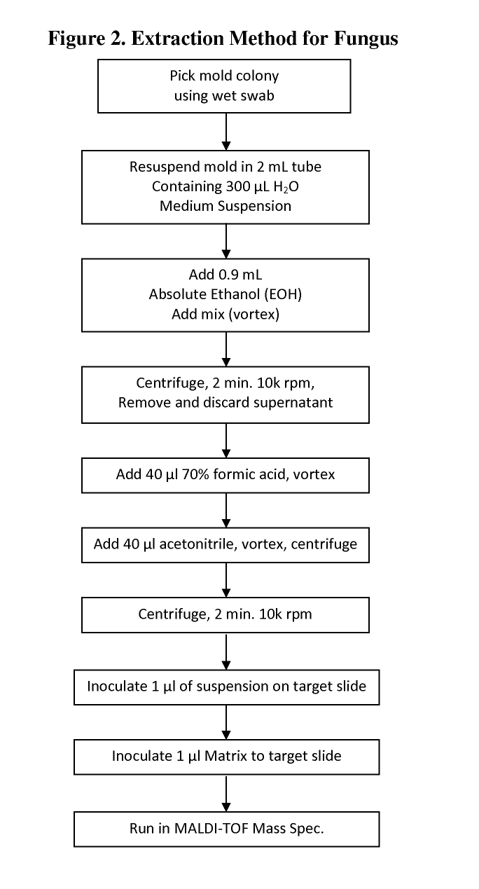

FIG. 2 shows a protocol for the inactivation and/or extraction of a fungus (mold or yeast) test sample, in accordance with one embodiment of the present invention. As shown in FIG. 2, a fungus sample was acquired using a wet or moist swab and transferred to a container containing 300 μL of suspension medium. 0.9 mL of absolute ethanol was added and the mixture was vortexed. The fungus were then pelleted by centrifugation for 2 minutes at 10,000 g and the supernatant removed. The pellet was then resuspended in 40 μL of 70% formic acid (FA), vortexed and 40 μL of acetonitrile (ACN) was added. The container was centrifuged for 2 minutes at 10,000 g and the supernatant recovered. A 1 μL aliquot of the supernatant was transferred to and deposited on a mass spectrometry slide or plate. The sample is allowed to dry, and 1 μL of matrix (alpha-cyano-4-hydroxycinnamic acid (CHCA)) was added.

Test samples can then be interrogated by Matrix Assisted Laser Desorption Ionization Time-of-Flight (MALDI-TOF) mass spectrometry (VITEK® MS system (bioMérieux, Inc., Missouri, USA) and Launchpad Software (Shimadzu, Kyoto, Japan)) and the fungus test samples can be characterized and/or identified to the genus, species and/or strain level using either Saramis (bioMérieux, Inc., St. Louis, Mo.) or SpectraIdentifier (bioMérieux, Inc., St. Louis, Mo.).

### Experimental

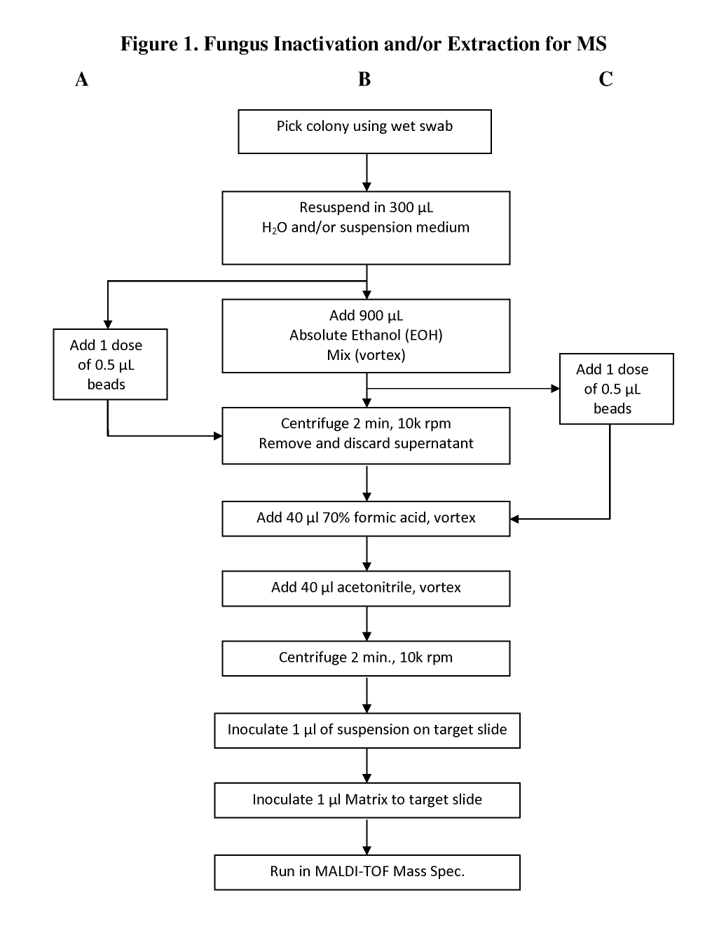

FIG. 1 shows three possible sample preparation protocols for the inactivation and extraction of a fungus test sample, in accordance with one embodiment of the present invention.

As shown in FIG. 1, protocol A employs a mechanical step for inactivation and extraction. In accordance with protocol 1, a fungus test sample was acquired using a wet or moist swab and transferred to a container comprising 300 μL of sterile water and 0.5 mm beads. The container was vortexed for 10 minutes, centrifuges and the supernatant recovered. A 1 μL aliquot of the supernatant was transferred to and deposited on a mass spectrometry slide or plate. The sample is allowed to dry, and 1 μL of matrix (alpha-cyano-4-hydroxycinnamic acid (CHCA)) was added.

Protocol B of FIG. 1 employs chemical steps for inactivation and extraction. In accordance with protocol 1, a fungus test sample was acquired using a wet or moist swab and transferred to a container comprising 300 μL of sterile water. 900 μL of 100% ethanol was added and mixed by vortex. The fungus were then pelleted by centrifugation for 2 minutes at 10,000 g and the supernatant removed. The pellet was then resuspended in 40 μL of 70% formic acid (FA), vortexed and 40 μL of 100% acetonitrile (ACN) was added. The container was centrifuged for 2 minutes at 10,000 g and the supernatant recovered. A 1 μL aliquot of the supernatant was transferred to and deposited on a mass spectrometry slide or plate. The sample is allowed to dry, and 1 μL of matrix (alpha-cyano-4-hydroxycinnamic acid (CHCA)) was added.

As shown in FIG. 1, protocol C employs chemical and mechanical steps for inactivation and extraction. In accordance with protocol 3, a fungus test sample was acquired using a wet or moist swab and transferred to a container comprising 300 μL of sterile water. 900 μL of 100% ethanol was added and the mixture was vortexed. The fungus were then pelleted by centrifugation for 2 minutes at 10,000 g and the supernatant removed. 0.5 mm beads were added to the pellet, the pellet was then resuspended in 40 μL of 70% formic acid (FA), vortexed for 10 minutes and 40 μL of 100% acetonitrile (ACN) was added. The container was centrifuged for 2 minutes at 10,000 g and the supernatant recovered. A 1 μL aliquot of the supernatant was transferred to and deposited on a mass spectrometry slide or plate. The sample is allowed to dry, and 10 μL of matrix (alpha-cyano-4-hydroxycinnamic acid (CHCA)) was added.

Test samples were then interrogated by Matrix Assisted Laser Desorption Ionization Time-of-Flight (MALDI-TOF) mass spectrometry (VITEK® MS system (bioMérieux, Inc., Missouri, USA) and Launchpad Software (Shimadzu, Kyoto, Japan)) and the fungus test samples were characterized and/or identified to the genus, species and/or strain level using SpectraIdentifier (bioMérieux, Inc., St. Louis, Mo.), an internal database containing spectra of 4 fungus species, Aspergillus fumigatus, Aspergillus flacus, Aspergillus versicolor and Aspergillus niger.

Fungus test samples were acquired and tested after 2 days or 8 days of culture using one of the four protocols shown in FIG. 1. Discrimination and/or identification of species was determined using cluster analysis. Results are shown in Tables 1-2.

As shown in Tables 1 and 2, using protocols B and C a sufficient number of peaks were obtained for species differentiation (i.e. typically more than 80 peaks per spectrum). For both protocols A and B, the acquired spectra were deemed to be of sufficient quality to allow for species differentiation. Furthermore, as shown in Tables 1 and 2, no identification was obtained for Penicillium chysogenum and Fusarium nygamay, two species for which reference spectra were not included in the database.

TABLE 1

| | | | | H2O + Beads | | | H2O/EtOH/FA/Acetonitrile | | | H2O/EtOH/FA/Acet. + Beads | | |
|---|---|---|---|---|---|---|---|---|---|---|---|---|
| | | Reference ID | | No. | | | No. | | | No. | | |
| Strain | API No. | (Saramis) | Culture age | peaks | Species | Prob. | Peaks | Species | Prob. | Peaks | Species | Prob. |
| A. niger | 1006067 | A. niger | T2 | 54 | A. fumigatus | 100 | 100 | A. fumigatus | 99.99 | 104 | A. fumigatus | 99.99 |
| | | | | 50 | A. fumigatus | 99.99 | 93 | A. fumigatus | 99.99 | 103 | A. fumigatus | 99.99 |
| | | | T8 | 52 | A. fumigatus | 100 | 91 | A. fumigatus | 99.99 | 96 | No ID | — |
| | | | | 50 | A. fumigatus | 99.99 | 83 | A. fumigatus | 99.99 | 99 | No ID | — |
| | 1006068 | TBV | T2 | 17 | NEP | — | 62 | A. niger | 99.75 | 97 | A. flavus | 99.99 |
| | | | | 16 | NEP | — | 66 | A. flavus | 99.83 | 0 | NEP | — |
| | | | T8 | 58 | A. niger | 99.95 | 105 | A. niger | 99.99 | 105 | A. niger | 99.99 |
| | | | | 55 | A. niger | 99.99 | 115 | A. niger | 99.99 | 98 | A. niger | 99.99 |
| A. fumigatus | 1006108 | No Growth | T2 | 86 | A. fumigatus | 99.99 | 128 | A. fumigatus | 99.99 | 130 | A. fumigatus | 99.99 |
| | | | | 82 | A. fumigatus | 99.99 | 113 | A. fumigatus | 99.99 | 119 | A. fumigatus | 99.99 |
| | | | T8 | 44 | A. fumigatus | 100 | 64 | A. fumigatus | 99.99 | 53 | A. fumigatus | 100 |
| | | | | 43 | A. fumigatus | 100 | 67 | A. fumigatus | 100 | 69 | A. fumigatus | 100 |
| | 1006117 | A. fumigatus | T2 | 73 | A. fumigatus | 99.99 | 113 | A. fumigatus | 99.99 | 86 | A. fumigatus | 99.99 |
| | | | | 57 | A. fumigatus | 100 | 125 | A. fumigatus | 99.99 | 104 | A. fumigatus | 99.99 |
| | | | T8 | 37 | A. fumigatus | 100 | 73 | A. fumigatus | 99.99 | 74 | A. fumigatus | 100 |
| | | | | 42 | A. fumigatus | 100 | 80 | A. fumigatus | 99.99 | 77 | A. fumigatus | 99.99 |
| A. versicolor | 1004136 | No ID | T2 | 29 | A. versicolor | 99.96 | 143 | No ID | — | 109 | No ID | — |
| | | | | 30 | No ID | — | 129 | No ID | — | 94 | No ID | — |
| | | | T8 | 115 | No ID | — | 128 | No ID | — | 143 | No ID | — |
| | | | | 119 | No ID | — | 123 | No ID | — | 141 | No ID | — |
| | 1010052 | — | T2 | 85 | A. fumigatus | 99.99 | 118 | A. fumigatus | 99.99 | 110 | A. fumigatus | 99.99 |
| | | | | 57 | A. fumigatus | 99.99 | 134 | A. fumigatus | 99.17 | 99 | A. fumigatus | 99.99 |
| | | | T8 | 48 | A. fumigatus | 100 | 83 | A. fumigatus | 99.99 | 95 | A. fumigatus | 99.99 |
| | | | | 48 | A. fumigatus | 100 | 91 | A. fumigatus | 99.99 | 95 | A. fumigatus | 99.99 |

*TBV = To Be Verified; NEP = Not Enough Peaks; No ID = No Identification

TABLE 2

| | | | | | | | H2O/EtOH/FA/ | | | H2O/EtOH/FA/ | | |
|---|---|---|---|---|---|---|---|---|---|---|---|---|
| | | Reference | | H2O + Beads | | | Acetonitrile | | | Acet. + Beads | | |
| | | ID | Culture | No. | | | No. | | | No. | | |
| Strain | API No. | (Saramis) | age | peaks | Species | Prob. | Peaks | Species | Prob. | Peaks | Species | Prob. |
| A. flavus | 1006131 | A. flavus | T2 | 81 | A. flavus | 99.99 | 139 | A. flavus | 99.99 | 112 | A. flavus | 99.99 |
| | | | | 76 | A. flavus | 99.99 | 135 | A. flavus | 99.99 | 115 | A. flavus | 99.99 |
| | | | T8 | 80 | A. flavus | 99.99 | 132 | A. flavus | 99.99 | 139 | A. flavus | 99.99 |
| | | | | 56 | A. flavus | 100 | 123 | A. flavus | 99.99 | 133 | A. flavus | 99.99 |
| | 1006132 | A. flavus | T2 | 90 | A. flavus | 99.99 | 151 | A. flavus | 99.99 | 114 | A. flavus | 99.99 |
| | | | | 77 | A. flavus | 99.99 | 139 | A. flavus | 99.88 | 121 | A. flavus | 99.99 |
| | | | T8 | 102 | A. flavus | 99.99 | 151 | A. flavus | 99.99 | 162 | A. flavus | 99.99 |
| | | | | 102 | A. flavus | 99.99 | 142 | A. flavus | 99.99 | 147 | A. flavus | 99.99 |
| P. chysogenum | 1105058 | N/A | T2 | 23 | Mal. furfur | — | 68 | No ID | — | 83 | No ID | — |
| | | | | 29 | No ID | — | 73 | No ID | — | 86 | No ID | — |
| | | | T8 | 27 | C. parapsilosis | — | 25 | No ID | — | 28 | No ID | — |
| | | | | 26 | A. niger | 77.51 | 33 | No ID | — | 27 | No ID | — |
| | 1105059 | N/A | T2 | 77 | No ID | — | 109 | No ID | — | 101 | No ID | — |
| | | | | 68 | No ID | — | 106 | Debaryo. | 78.68 | 94 | No ID | — |
| | | | | | | | | polymorp. | | | | |
| | | | T8 | 34 | No ID | — | 97 | No ID | — | 81 | No ID | — |
| | | | | 35 | No ID | — | 100 | Debaryo. | 79.96 | 90 | No ID | — |
| | | | | | | | | polymorp. | | | | |
| F. nygamai | 1105024 | N/A | T2 | 62 | No ID | — | 119 | No ID | — | 133 | No ID | — |
| | | | | 74 | C. famata | — | 129 | No ID | — | 145 | No ID | — |
| | | | T8 | 39 | Cryo. terreus | — | 137 | No ID | — | 137 | No ID | — |
| | | | | 43 | C. dattila | — | 144 | No ID | — | 138 | No ID | — |
| | 1105025 | N/A | T2 | 44 | No ID | — | 101 | No ID | — | 91 | No ID | — |
| | | | | 48 | No ID | — | 99 | No ID | — | 123 | No ID | — |
| | | | T8 | 20 | C. glabrate | — | 74 | No ID | — | 111 | No ID | — |
| | | | | 18 | NEP | — | 83 | No ID | — | 97 | No ID | — |

*NEP = Not Enough Peaks; No ID = No Identification

That which is claimed is:

1. A method for inactivation and/or extraction of a fungus test sample, the method comprising the following steps:
(a) acquiring an unknown fungus sample from a solid or semi-solid medium and resuspending the unknown fungus sample to a container containing water and/or a suspension medium; and
(b) adding ethanol to the container and mixing;
(c) pelleting the fuss in the test sample by centrifugation and removing the supernatant from the test sample;
(d) resuspending the fungus pellet in formic acid and mixing; and
(e) adding acetonitrile to the container and mixing the container;
(f) centrifuging the container; and
(g) recovering the supernatant.

2. The method as claimed in claim 1, wherein the method further comprises adding beads in step (b) and mixing the sample by bead beating and/or by vortex.

3. The method as claimed in claim 1, wherein the method further comprises the following additional steps:
(h) transferring an aliquot of the test sample to a slide or plate;
(i) interrogating the test sample on the slide or plate by mass spectrometry to acquire a mass spectrum of the fungus; and
(j) characterizing and/or identifying said fungus in the test sample by comparison of the measured mass spectrum with reference mass spectra.

4. The method as claimed in claim 3, wherein step (h) comprises transferring a 1 μL aliquot of the test sample to a mass spectrometry slide or plate, allowing the aliquot to dry and subsequently adding a matrix.

5. The method as claimed in claim 1, wherein said fungus sample is acquired from the solid or semi-solid medium using a wet swab.

6. The method of any of claim 1, wherein said unknown fungus is acquired from a mycelium sample or spore sample.

7. The method as claimed in claim 3, wherein said fungus is characterized and/or identified to the genus, species and/or strain level using MALDI-TOF mass spectrometry.

8. The method as claimed in claim 1, wherein the unknown fungus sample is a mold.

9. The method as claimed claim 8, wherein the unknown fungus sample is Aspergillus.

10. The method as claimed in claim 1, wherein the unknown fungus sample is a yeast.

11. The method as claimed in claim 1, wherein ethanol is added to a final concentration of from about 50% to about 90%.

12. The method as claimed in claim 1, wherein the pellet in step (d) is re-suspending in 70% formic acid.

13. The method as claimed in claim 1, wherein acetonitrile is added in step (e) to a final concentration of from about 35% to about 65%.

14. A method for inactivation and/or extraction of a fungus test sample, the method comprising the following steps:
(a) acquiring an unknown fungus sample from a solid or semi-solid medium and resuspending the unknown fungus sample in a container containing 300 μL a suspension medium;
(b) adding 900 μL of absolute ethanol to the container and mixing;
(c) pelleting the fuss in the test sample by centrifugation and removing the supernatant from the test sample;
(d) resuspending the fungus pellet in 40 μL of 70% formic acid and mixing;
(e) adding 40 μL of acetonitrile to the container and mixing;
(f) centrifuging the container;
(g) recovering the supernatant;
(h) transferring an aliquot of the supernatant to a slide or plate;
(i) interrogating the test sample on the slide or plate by mass spectrometry to acquire a mass spectrum of the fungus; and
(j) characterizing and/or identifying said fungus in the test sample by comparison of the measured mass spectrum with reference mass spectra.

15. The method as claimed in claim 14, wherein said fungus sample is acquired from the solid or semi-solid medium using a wet swab.

16. The method as claimed in claim 14, wherein the method further comprises adding beads in step (b) and mixing the sample by bead beating and/or by vortex.

17. The method as claimed in claim 14, wherein the unknown fungus sample is a mold.

18. The method as claimed claim 14, wherein the unknown fungus sample is Aspergillus.

19. The method as claimed in claim 14, wherein the unknown fungus sample is a yeast.

20. The method as claimed in claim 14, wherein said fungus is characterized and/or identified to the genus, species and/or strain level using MALDI-TOF mass spectrometry.
